(19) United States
(12) Patent Application Publication
(10) Pub. No.: US 2007/0293365 A1
(43) Pub. Date: Dec. 20, 2007

(54) Planetary gear with radial through-bore

(75) Inventor: Helmut Thoma, Loeffingen (DE)

Correspondence Address: Maginot, Moore & Beck;Chase Tower, Suite 3250, 111 Monument Circle, Indianapolis, IN, 46204, US

(73) Assignee: IMS GEAR GmbH, Eisenbach (DE)

(21) Appl. No.: 11/804,014

(22) Filed: May 16, 2007

(30) Foreign Application Priority Data
May 17, 2006 (DE) 10 2006 023 380.8

(51) Int. Cl. F16H 57/08

(52) U.S. Cl. 475/331

(57) ABSTRACT

A revolving gear arrangement has at least two toothed wheels, which are lubricated with oil or grease and which mesh together in a rolling gap, wherein at least one of them is a revolving gear which is rotatably mounted by means a slip fit joint on a bolt. The bolt-mounted rotating gear is equipped with at least one radial bore, which connects the meshing space of the gear tooth systems with the slip fit joint.

### FIELD OF THE INVENTION

The invention relates to a revolving gear arrangement having at least two mutually intermeshing gears lubricated with grease, wherein at least one gear is a revolving gear that is rotationally mounted rotated on a bolt via a bearing.

### BACKGROUND

Revolving gear arrangements include, by way of example, planetary gear arrangements. The revolving gears, or planet gears, are usually designed as compact planet gears which are mounted on a bolt by means of a friction bearing. During the operation of the planetary gear arrangement, there is a risk that a seizure of the friction bearing could occur, for instance as a result of the generated heat. The friction bearing could also become damaged during a long stoppage period of the gear arrangement. Both of these wear-and-tear mechanisms affect the lifespan of the revolving gear arrangement.

### SUMMARY OF THE INVENTION

An object of embodiments of the present invention is, therefore, to increase the lifespan of a revolving gear arrangement.

This object is achieved in accordance with the characteristics of the main claim. For this purpose, a bolt-mounted rotating gear is provided with at least one radial bore, which connects the meshing space of the gear tooth structures with the bearing.

During the operation of the gear arrangement, the gears roll on each other. The lubricant is thus supplied in this manner into the bore of the bolt-mounted gear. With further supplying of the lubricant, the lubricant is forced into the slip fit joint and reduces the friction of the friction bearing. The wear and tear of the friction bearing is thus reduced and the lifespan of the gear arrangement is increased.

The above described features and advantages, as well as others, will become more readily apparent to those of ordinary skill in the art by reference to the following detailed description and accompanying drawings.

### BRIEF DESCRIPTION OF THE DRAWINGS

FIG. 1: shows a partial cutaway perspective view of a planetary gear arrangement according to an exemplary embodiment of the invention;

FIG. 2: shows a cross-section of a planet gear according to an embodiment of the invention;

FIG. 3: shows a top plan view of the planet gear of FIG. 2.

### DETAILED DESCRIPTION

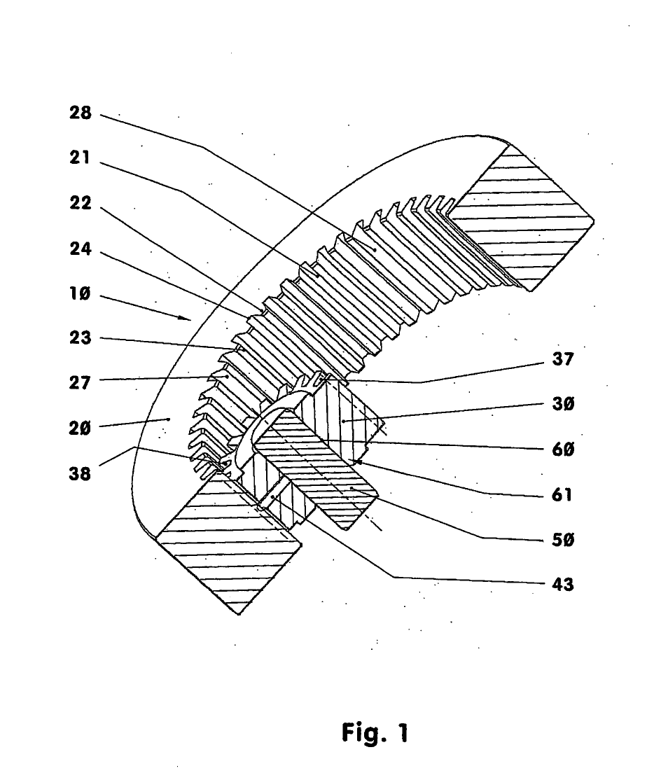

FIG. 1 shows parts of an exemplary revolving gear-planetary gear arrangement 10 including a ring gear 20, and a planet gear 30 intermeshing with the ring gear 20. The planetary gear arrangement 10 comprises for example one ring gear 20, three planetary wheels or gears 30 (only one shown for clarity of exposition), a planet carrier, not shown, and one sun gear, not shown, but which would be known to those of ordinary skill in the art. The ring gear 20 is further connected, for example, in a fixed manner on or in a housing. The planet carrier in this example forms the output.

The revolving gear arrangement 10 described herein can be also constructed in such a manner that the sun gear or the planet carrier is connected in a fixed manner with the housing. In the former case, the planet carrier or the ring gear 20 is the driven gear and the respective other structural components represent the output. However, when a planet carrier is connected in a fixed manner, then the gear constitutes a stationary gear, which can be employed, for example, in a pre-selection gearbox. In this case, the sun gear or the ring gear 20 is the driven gear and the respective other gear is the output gear.

It is also conceivable that all of the gears of the planetary gear arrangement 10 are designed as rotational gears. In such a case, the revolving gear-planetary gear arrangement 10 is in the form of a branching gear or a differential gear.

The revolving gear-planetary gear arrangement 10 illustrated in FIG. 1 is, for example, a gear having three shafts. The planetary gear 10 can be also designed in several stages, for example, as a combination of several planetary sets. The planetary gear 10 can be constructed as a positive gear having a positive transmission, or as a negative gear realized with a negative transmission.

The ring gear 20, the planet carrier and the sun gear are mutually arranged, for example, with a coaxial design. The planet gears 30 are, for example, arranged such that they are mutually shifted by 120 degrees on a common partial circle whose diameter corresponds to a half of the total of the toothed piece circle of the ring gear 20 and of the sun gear. In this embodiment, each of the planet gears, including the gear 30, is rotationally mounted on a respective central bolt 50. The bolts 50 are connected, for example, in a fixed manner with the planet carrier.

The ring gear 20, the planet gear 30 and the sun gear are in this embodiment example provided with involute toothing having a module of, for example, 0.8 mm. The inner toothed ring gear 20 has for example forty-eight teeth 22. The graduated tooth construction of the individual teeth of the planet gear 30 has, in this example, nineteen teeth 32. Also in this example, the ring gear 20 is 50% wider (i.e. in face width) than a single planet gear 30.

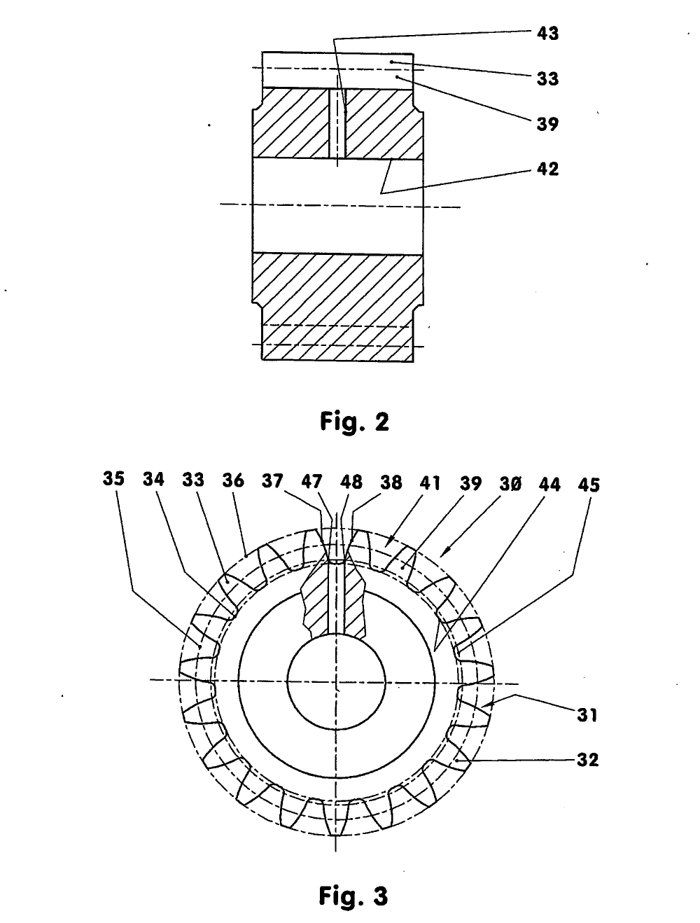

An exemplary embodiment of the planet gear 30 of FIG. 1 is shown in detail in FIGS. 2 and 3. In this embodiment, the length of the planet gear 30 is 8.7 mm. The diameter of the crown circle 36 is 15.9 mm, and has a tolerance of +0.1 mm. Moreover, the length of the gear tooth system 31 in this example is 1 mm shorter than the length of the planet gear 30. The gear tooth system 31 can be realized, for example, with the spherical design to prevent edge action of the planet gear 30 in the ring gear 20. The toothing design data of the embodiment example also defines an interrupted circle of the toothing 31 of 14.4 mm. The intermeshing or engagement angle of the toothing 31 is for example twenty degrees. The crown height of the individual teeth 32—i.e. the distance from the tooth tip 33 to the partial circle 35—corresponds for example to the module of the planet gear 30. The height of the root of the tooth 39—i.e. the distance from the tooth base 34 to the partial circle 35—is in this example higher by the tip clearance than the module. The tip clearance corresponds, for example, to a quarter of the module.

In order to accommodate the bolt 50, the planet gear 30 is provided with a cylindrical through-bore 42, which is oriented in the longitudinal (i.e. axial) direction of the planet gear 30. The through-bore 42 is configured to have a diameter of 5.03 mm and has a tolerance of +0.02 mm. The planet gear 30 which is indicated in FIGS. 2 and 3 also has a radially oriented cylindrical bore 43. The bore 43 connects and/or extends between the tooth root 34 and the through-bore 42. The diameter of the bore 43 is, in this exemplary embodiment, about 1 mm. The diameter of the bore 43 is thus larger than that of the module of the gear tooth system. Instead of having a single bore 43, the planet gear 30 can be equipped with several bores 43. These bores can be arranged so that they are mutually offset in the same tooth base 34, or they can be arranged in different tooth bases 34. Instead of the cylindrical bore 43, bores 43 that are tapered are also contemplated. Such tapered bores 43 would then be tapered, for example, from the tooth base 34 to the through-bore 42.

The through-bore 42 can be equipped with a longitudinal or a helical groove which penetrates the outlet of the radial bore 43.

The planet gear 30 is manufactured for example from casehardened steel, for instance 16MnCr5, product material number 1.7151. To carry out the manufacturing, the through-bore 42 and the gear tooth system 31 can suitably be manufactured first and the bore 43 created subsequently. Thereafter, the production part is casehardened.

The bolt 50 has a cylindrical cross-section, at least the portion within the planet gear 30. The cross-section of the bolt 50 within the planet gear 30 can be, for example, 5 mm. The bolt 50 advantageously consists of a material which is produced with powder metal technology, steel, etc.

During assembly, the planet gear 30 is installed onto the bolt 50 and secured in a manner that inhibits axial displacement. The bolt 50 and the through-bore 42 have a tolerance margin. After the assembly, the gear tooth systems 21, 31 are lubricated, for example, with grease. If the planetary gear 10 is arranged in a housing, the gear can be also lubricated with oil.

During the operation of the revolving gear-planetary gear arrangement 10, the planet gear 30 meshes, for example, with the ring gear 20. In such a case, the planet gear 30 comes into contact with a tooth flank 37 of the ring gear 20 in one point of the meshing line, at least in the simplified example of a pair of gears in a single plane. This point, the pitch point, is located with the rolling of the gear to a position in which the tooth root 39 is in the vicinity of the tooth tip 23 of the stationary ring gear 20. Upon further rotation of the planet gear 30, the momentary pitch point of between teeth flanks 37, 27 migrates along the rolling gap of the rolling gear 30 in the direction of the tooth root 39, and with a stationary ring gear 20 in the direction of the tooth tip 23. The length of the rolling gap will be in this case divided by the intersection point of the partial circle of both gear tooth systems 21, 31. As soon as the tooth tip 33 of the rolling gear 30 leaves the tooth flank 27 of the stationary ring gear 20, the opposite flank 38 of the tooth 32 of the rolling gear 30 meshes with the opposite flank 28 of the next tooth 22 of the stationary ring gear 20. In this manner, no contact is initiated between the tooth tip 33 of the rolling gear 30 and the tooth base 24 of the ring gear 20. The new pitch point is at the crown circle 36 of the rolling gear 30 and in the vicinity of the tooth root of the stationary gear 20. With further rotation of the rolling gear 30, the momentary pitch point migrates along the new rolling gap in the direction of the root circle 44 of the stationary ring gear 20 and in the direction of the tooth tip 33 of the rolling gear 30.

When both gears 20, 30 are rolled, the planet gear 30 turns or rotates upon the bolt 50. Both of these parts 30, 50 form a radial plain bearing 60 having a slip fit joint 61.

The space enclosed by the tooth base 34 and the tooth tip 23, as well as the respective rolling gaps, are referred to as the meshing space in the following text. When the toothed gears 20, 30 are rolled off, the lubricating material is distributed in the meshing space. As soon as the tooth gap 41 of the planet gear 30 is rolled off past a tooth 22 of the ring gear 20, grease is pressed into the bore 43. During repeated rolling of the gears 20, 30, additional grease is pressed into the bore 43 by the pumping effect and the grease which is already present in the bore 43 is supplied in the direction of the through-bore 42. This forces the grease into the slip fit joint 61 and thus distributes it with the rotation of the planet gear 30 onto the bolt 50 in the slip fit joint. With continuous lubrication, wear and tear of the slip fit joint is prevented. The lifespan of the planetary gear arrangement 10 is thus increased.

Due to the greater diameter of the bore 43, the compact revolving gear-planetary gear arrangement 10 described here always makes a sufficient amount of lubricant available for the slip fit joint 61. In this case, for example a tapered design of the bore 43 can have the function of a grease reservoir. The maximum diameter of the bore is in this cased limited by the distance between the end points 47, 48 on the foot point side of the rolling gaps of two opposite tooth flanks 37, 38 of the planet gear 30. The distance between these end points 47, 48 is greater than or the same as the distance between the intersection points of the base circle 45 with opposing tooth flanks of the gear tooth system 31. The latter can be calculated as follows:
l_{g}=d_{g}*(PI/z−(sₜ/Dₜ+inv(alpha)))
wherein:
l_{g}: the distance between the tooth flanks on the base circle
d_{g}: the diameter of the base circle
PI: circle constant
Z: number of teeth
Sₜ: tooth thickness and the thickness of the gaps on the partial circle
Dₜ: diameter of the partial circle
Alpha: meshing angle of the gear tooth system

In the example provided in the embodiment, this value is 0915 mm.

### LIST OF REFERENCE SYMBOLS

10 revolving gear-planetary gear arrangement, planetary gear arrangement
20 ring gear, stationary gear
21 gear tooth system
22 a tooth of part 20
23 tooth tip
24 tooth base
27 tooth flank
28 opposite flank
30 revolving gear, planet gear, rotating gear
31 gear tooth system
32 a tooth of part 30
33 tooth tip
34 tooth base
35 partial circle
36 crown line
37 tooth flank
38 opposite flank
39 tooth root
41 tooth gap
42 through-bore
43 radially oriented bore
44 root circle
45 base circle of 30
47 end point of the rolling gap on 37
48 end point of the rolling gap on 38
50 bolt
60 radial friction bearing
61 slip fit joint

1. A revolving gear arrangement having at least two gears lubricated with oil or with grease and which mesh with each other, the two gears having respective gear tooth systems defining a meshing space therebetween, wherein at least a first gear is a revolving gear which is rotatably mounted on a bolt using a bearing, and wherein the first gear includes at least one radial bore, the radial bore connecting the meshing space of the gear tooth systems with the bearing.

2. The revolving gear arrangement according to claim 1, wherein the bore is arranged in a tooth base of the gear tooth system of the first gear.

3. The revolving gear arrangement according to claim 2, wherein a diameter of the bore is smaller than a distance between end points on a foot point side of the rolling gaps of two tooth flanks located opposite each other of the first gear.

4. The revolving gear arrangement according to claim 2, wherein a diameter of the bore is greater than that of a module of the revolving gear arrangement.

5. The revolving gear arrangement according to claim 1, wherein the bolt is fixed to a planet carrier.

6. The revolving gear arrangement according to claim 1, wherein the first gear meshes with a ring gear.

7. The revolving gear arrangement according to claim 1, wherein the rotating toothed wheel is configured to mesh with a sun gear.

8. An arrangement for use in a planetary gear arrangement, the arrangement comprising:
a first rotating gear having a first gear tooth system, the first gear is rotatably mounted on a bolt using a bearing;
a second gear having a second gear tooth system and comprising a ring gear;
wherein the first rotating gear and the second gear are lubricated with oil or with grease and mesh with each other, the first and second gear tooth systems defining a meshing space therebetween, and wherein the first rotating gear includes at least one radial bore, the radial bore extending from the meshing space of the gear tooth systems to the bearing.

9. The arrangement according to claim 8, wherein the bore is arranged in a tooth base of the first gear tooth system.

10. The arrangement according to claim 9, wherein a diameter of the bore is smaller than a distance between end points on a foot point side of the rolling gaps of two tooth flanks located opposite each other of the first rotating gear.

11. The arrangement according to claim 9, wherein a diameter of the bore is greater than that of a module of the arrangement.

12. The arrangement according to claim 8, wherein the bolt is configured to be fixed to a planet carrier.
